(19) United States
(12) Patent Application Publication
(10) Pub. No.: US 2014/0172508 A1
(43) Pub. Date: Jun. 19, 2014

(54) System and Method For Generating Student Mirror Maps In A University

(71) Applicant: SRM Institute of Science and Technology, West Mambalam (IN)

(72) Inventors: Sridhar Varadarajan, Bangalore (IN); Preethy Iyer, Bangalore (IN); Meera Divya Munipalli Venugopal, Bangalore (IN)

(73) Assignee: SRM Institute of Science and Technology, West Mambalam (IN)

(21) Appl. No.: 14/072,054

(22) Filed: Nov. 5, 2013

(30) Foreign Application Priority Data
Dec. 14, 2012 (IN) 5231CHE2012

(51) Int. Cl. G06Q 50/20; G06Q 30/02

(52) U.S. Cl. CPC G06Q 50/20; G06Q 30/0204
USPC 705/7.33

(57) ABSTRACT

An educational institution (also referred as a university) is structurally modeled using a university model graph. A key benefit of modeling of the educational institution is to help in an introspective analysis by the educational institute. The analysis of the various activities performed on the university campus by the various entities (such as students) of the university leads to the generation of student specific activity maps. These maps play a role in counseling students in organizing and planning of their activities in the context of the university. A system and method for automated generation of mirror maps involves the combined analysis of a set of activity maps of a set of students to measure their similarities. Such similarities help, for example, in the process of formation of teams, and identification of meeting times and venues.

1. A reference is made to the applicants' earlier Indian patent application titled “System and Method for an Influence based Structural Analysis of a University” with the application number 1269/CHE2010 filed on 6 May 2010.

2. A reference is made to another of the applicants' earlier Indian patent application titled “System and Method for Constructing a University Model Graph” with an application number 1809/CHE/2010 and filing date of 28 Jun. 2010.

3. A reference is made to yet another of the applicants' earlier Indian patent application titled “System and Method for University Model Graph based Visualization” with the application number 1848/CHE/2010 dated 30 Jun. 2010.

4. A reference is made to yet another of the applicants' earlier Indian patent application titled “System and method for what-if analysis of a university based on university model graph” with the application number 3203/CHE/2010 dated 28 Oct. 2010.

5. A reference is made to yet another of the applicants' earlier Indian patent application titled “System and method for comparing universities based on their university model graphs” with the application number 3492/CHE/2010 dated 22 Nov. 2010.

6. A reference is made to the applicant's copyright document titled “Activity and Interaction based Holistic Student Modeling in a University: ARIEL UNIVERSITY STUDENT Process Document” that is being forwarded under The Registrar of Copyright, Copyright Office, New Delhi.

7. A reference is made to yet another of the applicants' earlier Indian patent application titled “System and Method for Student Activity Gathering in a University” with the application number 3905/CHE/2011 dated 14 Nov. 2011.

8. A reference is made to yet another of the applicants' earlier Indian patent application titled “System and method for generating student activity flows in a university” with the application number 4157/CHE/2011 dated 30 Nov. 2011.

9. A reference is made to yet another of the applicants' earlier Indian patent application titled “System and method for generating student activity maps in a university.” Under filing process.

### FIELD OF THE INVENTION

The present invention relates to the analysis of the information about a university in general, and more particularly, the analysis of the activities of the university associated with structural representations. Still more particularly, the present invention relates to a system and method for automatically determining the similarities among a group of students of the university based on the associated activity maps.

### BACKGROUND OF THE INVENTION

An Educational Institution (EI) (also referred as University) comprises of a variety of entities: students, faculty members, departments, divisions, labs, libraries, special interest groups, etc. University portals provide information about the universities and act as a window to the external world. A typical portal of a university provides information related to (a) Goals, Objectives, Historical Information, and Significant Milestones, of the university; (b) Profile of the Labs, Departments, and Divisions; (c) Profile of the Faculty Members; (d) Significant Achievements; (e) Admission Procedures; (f) Information for Students; (g) Library; (h) On- and Off-Campus Facilities; (i) Research; (j) External Collaborations; (k) Information for Collaborators; (l) News and Events; (m) Alumni; and (n) Information Resources. The educational institutions are positioned in a very competitive environment and it is a constant endeavor of the management of the educational institution to ensure to be ahead of the competition. This calls for a critical analysis of the overall functioning of the university and help suggest improvements so as enhance the overall strength aspects and overcome the weaknesses. Consider a typical scenario of assessing of a student of the Educational Institution. In order to achieve a better holistic assessment, it is required to counsel the student not only based on the curricular activities but also those other but related activities. Further, it is also required to counsel students to organize and plan various of their activities on the university campus. This requires the use of the activity maps associated with the students to determine the broad similarities (notionally called as mirror maps) among the students. Such similarities help pick suitable teams, meeting times, and meeting venues that can largely help students to excel in their activities.

### DESCRIPTION OF RELATED ART

U.S. Pat. No. 7,925,529 to Cragun; Brian John (Rochester, Minn.), Day; Paul Reuben (Rochester, Minn.) for “Method and meeting scheduler for automated meeting scheduling using delegates, representatives, quorums and teams” (issued on Apr. 12, 2011 and assigned to International Business Machines Corporation (Armonk, N.Y.)) provides a method, meeting scheduler, and computer program product for automated meeting scheduling using delegates, representatives, quorums, and teams.

U.S. Pat. No. 7,990,266 to Burnham; Robert (Idaho Springs, Colo.), Howard; Cliff (Dacono, Colo.), Love; Susan (Broomfield, Colo.), Madsen; Paul (Englewood, Colo.), Rishea; John (Denver, Colo.) for “Location- and direction-enhanced automatic reminders of appointments” (issued on Aug. 2, 2011 and assigned to Avaya Inc. (Basking Ridge, N.J.)) provides an automatic appointment reminder system that uses location and/or direction of travel of the reminder recipient relative to appointments to affect the time of sending of appointment reminders to the user.

U.S. patent application Ser. No. 13/049,067 titled “System and method for predicting meeting subjects, logistics, and resources” by Dhara; Krishna Kishore; (Dayton, N.J.); Krishnaswamy; Venkatesh; (Holmdel, N.J.); Shim; Eunsoo; (Princeton Junction, N.J.); Wu; XiaoTao; (Edison, N.J.) (filed on Mar. 16, 2011 and assigned to Avaya Inc. (Basking Ridge, N.J.)) describes a system for predicting the subject, logistics, and resources of associated with a communication event based on the analysis of the past behavior patterns with respect to the subject, logistics, and resources of communication events to predict logistics including people to invite, time and date of the meeting, its duration, location, and anything else useful in helping potential participants gather together.

European Patent Application EP 2 410 476 A1 titled “Automatic meeting scheduling and available time display” by Ayatollahi, Mina (Waterloo Ontario N2L 3L3 (CA)) and Garg, Neeraj (Milton Ontario L9T 6N6 (CA)) (filed on Jul. 23, 2010 and assigned to Research In Motion Limited (Waterloo, ON N2L 3W8 (CA)) describes an approach for facilitating automatic meeting scheduling without the need to open a calendar application to discuss and discover shared available time.

European Patent Application EP 2 442 260 A1 titled “Meeting room scheduling system including room occupancy γ sensor and related methods” by Adams, Neil Patrick (Waterloo Ontario N2L 3L3 (CA) and Davis, Dinah Lea Marie (Waterloo Ontario N2L 3L3 (CA)) (filed on Sep. 23, 2010 and assigned to Research In Motion Limited (Waterloo, ON N2L 3W8 (CA)) describes a meeting room scheduling system with a room occupancy sensor and a controller coupled to the room occupancy sensor to schedule periodic meetings for the meeting room with a requested meeting time based on actual occupancy times of the meeting room over a plurality of the periodic meetings.

“SCMEnv: A software engineering environment for SCM systems based on asynchronous teams” by Haiying LI and Yujun ZHENG (appeared in the Journal of Computational Information Systems 7:4 (2011) 1222-1229) describes a practical software engineering tool for A-Team based Supply Chain Management system development wherein an A-Team consists of a population of candidate solutions and multiple agents.

“Scheduling problems at a university: a real-world example” by Marko Cupic and Tin Franovic (appeared in Int. J. Knowledge and Learning, Vol. 7, Nos. 1/2, 2011) discusses the development and usage of the various kinds of educational activity schedulers used at faculty level.

“Improving business process quality through exception understanding, prediction, and prevention” by Daniela Grigori, Fabio Casati, Umesh Dayal, and Ming-Chien Shan (appeared in Proceedings of the 27th VLDB Conference, Roma, Italy, 2001) describes an approach and a tool suite for exception analysis, prediction, and prevention so as to enhance business process quality as part of a workflow management system.

The known systems do not address the issues of practical applications of the student activity maps associated with students in the university context. The present invention provides for a system and method for applications such as cohesive team formation, and meeting time and venue identification in a university so as to be of assistance in the holistic assessment and counseling of the students.

### SUMMARY OF THE INVENTION

The primary objective of the invention is to determine the broad similarities among a group of students (notionally called as mirror maps) based on the activity maps associated with the students in the context of a university.

One aspect of the invention is to compute a cohesive measure between any two given students based on their activity maps.

Another aspect of the invention is to match two maps of the same type.

Yet another aspect of the invention is to assist in the formation of a team of students for a particular purpose.

Another aspect of the invention is to determine as many cohesive teams as possible given a group of students.

Yet another aspect of the invention is to determine a vacant time slot given a group of students.

Another aspect of the invention is to determine a maximal subset of students for whom a vacant time slot can be determined given a set of students.

Yet another aspect of the invention is to determine a subset of students for a given time slot and a given group of students.

Another aspect of the invention is to compute a suitable location for a given group of students.

Yet another aspect of the invention is to compute a maximal subset of students for whom a suitable location can be determined given a group of students.

Another aspect of the invention is to determine a subset of students for a given location and a given set of students.

In a preferred embodiment, the present invention provides a system and method for
computing a plurality of cohesive measures associated with a plurality of students based on a plurality of activity maps;
computing a team of the plurality of teams based on the plurality of students and the plurality of cohesive measures;
computing a plurality of cohesive teams of said plurality of teams based on the plurality of cohesive measures;
computing a meeting time of the plurality of meeting times for the plurality of students based on the plurality of TM1s of the plurality of activity maps;
computing a maximal team 1 of the plurality of teams with a meeting time of the plurality of meeting times based on the plurality of TM1s;
computing a team 1 of the plurality of teams based on a time period of said plurality of meeting times and the plurality of TM1s;
computing a meeting venue of the plurality of meeting venues for the plurality of students based on the plurality of LM1s of the plurality of activity maps and the plurality of LM2s of the plurality of activity maps;
computing a maximal team 2 of the plurality of teams with a meeting venue of the plurality of meeting venues based on the plurality of LM1s, and the plurality of LM2s; and
computing a team 2 of said plurality of teams based on a location of the plurality of meeting venues, a plurality of LM1s, and a plurality of LM2s.

### BRIEF DESCRIPTION OF THE DRAWINGS

FIG. 1 provides a typical assessment of a university.

FIG. 1A provides a partial list of entities of a university.

FIG. 2 provides a typical list of student-related processes.

FIG. 2A provides a typical list of student-related meta-activities.

FIG. 2B provides a typical list of student locations.

FIG. 2C provides an illustrative list of meta-locations.

FIG. 2D provides a typical list of time intervals.

FIG. 3 depicts the various types of cluster maps.

FIG. 3A provides an illustrative cluster structure and related information.

FIG. 4 provides an illustrative list of the uses of the activity maps.

FIG. 4A provides an overview of Mirror Map System.

FIG. 5 provides an approach for cohesive measure computation.

FIG. 6 provides an approach for map matching.

FIG. 7 provides an approach for team formation.

FIG. 7A provides an approach for determining as many cohesive teams as possible.

FIG. 8 provides an approach for vacant time slot computation.

FIG. 8A provides an approach for determining a maximal subset of students for whom a vacant time slot can be determined.

FIG. 8B provides an approach for determining a subset of students for a given time slot.

FIG. 9 provides an approach for suitable location computation.

FIG. 9A provides an approach for determining a maximal subset of students for whom a suitable location can be determined.

FIG. 9B provides an approach for determining a subset of students for a given location.

### DETAILED DESCRIPTION OF THE PREFERRED EMBODIMENTS

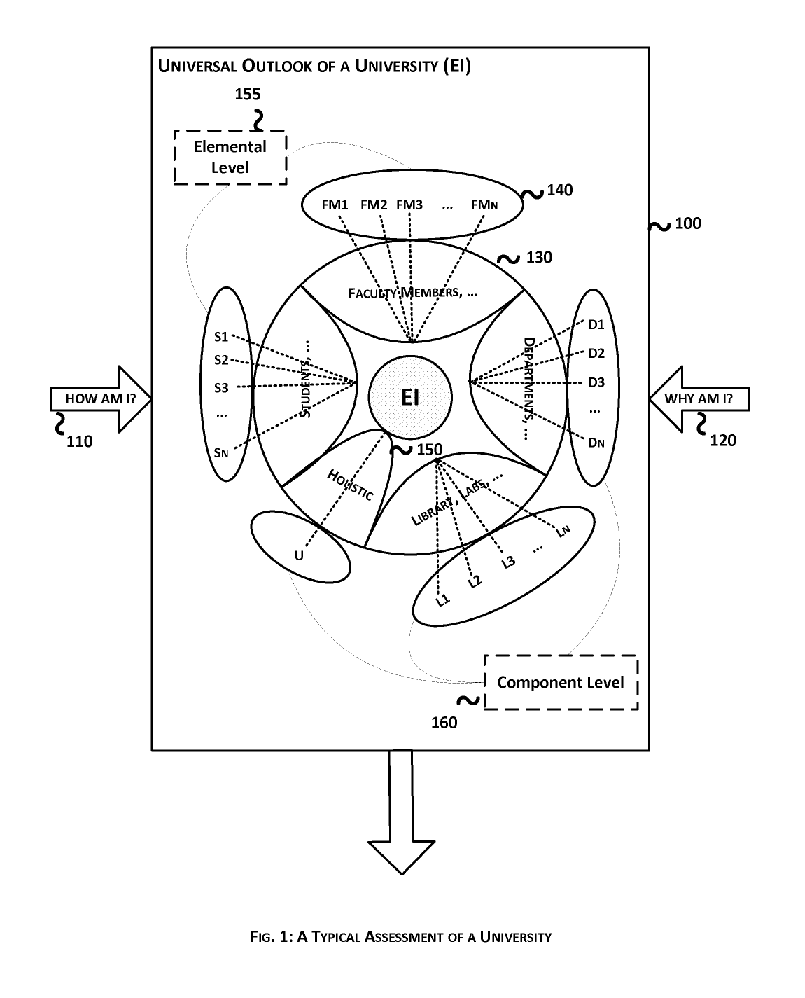

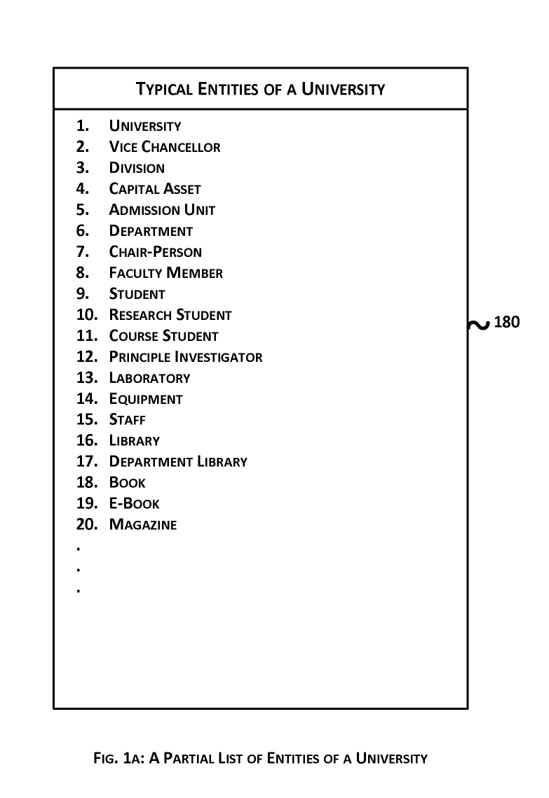

FIG. 1 provides a typical assessment of a university. An Educational Institution (EI) or alternatively, a university, is a complex and dynamic system with multiple entities and each interacting with multiple of other entities. The overall characterization of the EI is based on a graph that depicts these multi-entities multiple relationships. An important utility of such a characterization is to assess the state and status of the EI. What it means is that, in the context of the EI, it is helpful if every of the entities of the EI can be assessed. Assessment of the EI as a whole and the constituents at an appropriate level gives an opportunity to answer the questions such as “How am I?” and “Why am I?”. That is, the assessment of each of the entities and an explanation of the same can be provided. Consider a STUDENT entity: This is one of the important entities of the EI and in any EI there are several instances of this entity that are associated with the students of the EI. The assessment can be at STUDENT level or at S1 (a particular student) level. 100 depicts the so-called “Universal Outlook of a University” and a system that provides such a universal outlook is capable of addressing “How am I?” (110) and “Why am I?” (120) queries. The FACULTY MEMBER entity (130) characterizes the set of all faculty members FM1, FM2, . . . , FMn (140) of the EI. The holistic assessment (150) helps answer How and Why at university level. Observe that there are two distinct kinds of entities: One class of entities is at the so-called “Element” level (155)—this means that this kind of entities is at the atomic level as for as the university domain is concerned. On the other hand, there is a second class of entities at the so-called “Component” level (160) that accounts for remaining entities of the university domain all the way up to the University level. It is essential to use the determined multiple activity maps based on the activities of a student on the university campus in order to help counsel the student to achieve an improved holistic assessment.

FIG. 1A depicts a partial list of entities of a university. Note that a deep domain analysis would uncover several more entities and also their relationship with the other entities (180). For example, RESEARCH STUDENT is a STUDENT who is a part of a DEPARMENT and works with a FACULTY MEMBER in a LABORATORY using some EQUIPEMENT, the DEPARMENT LIBRARY, and the LIBRARY.

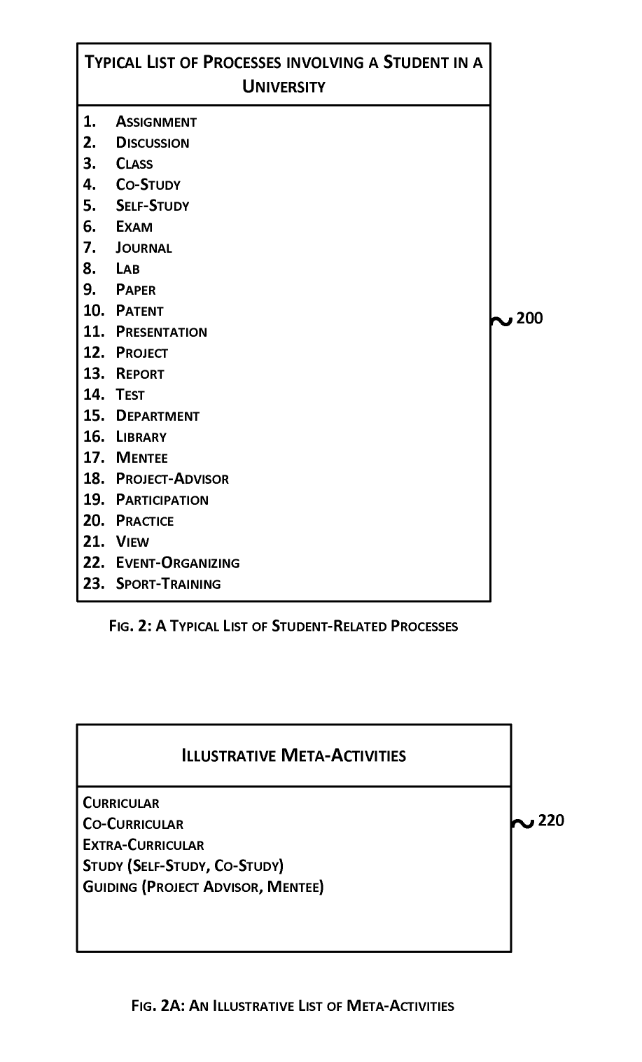

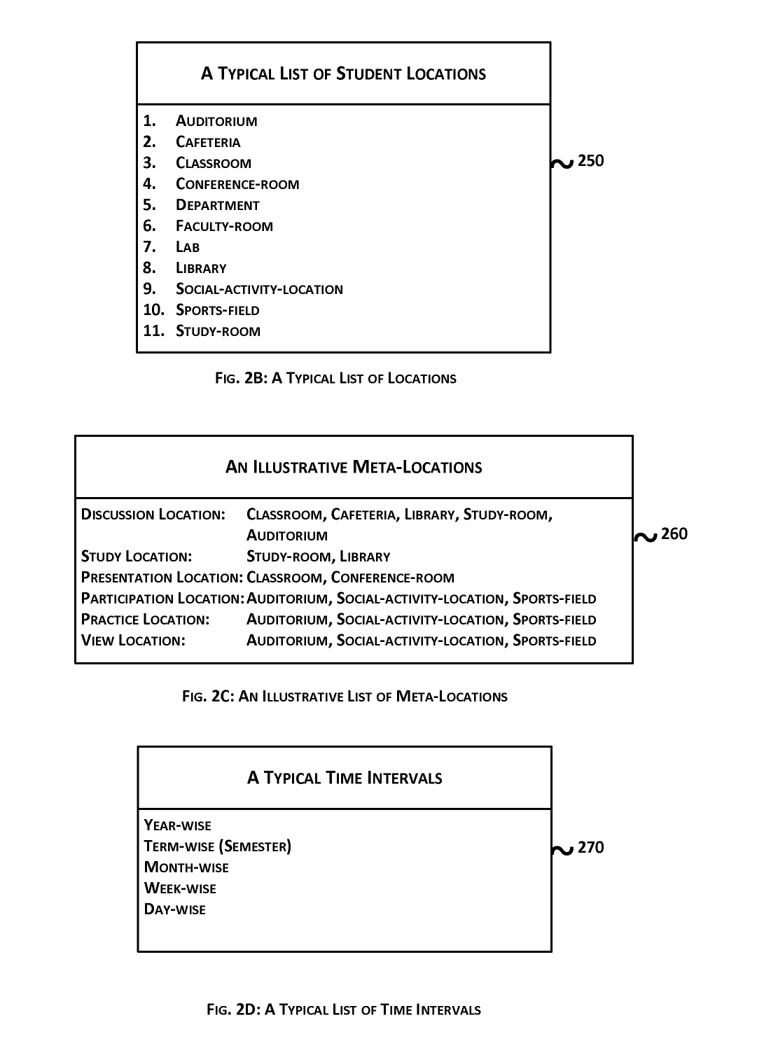

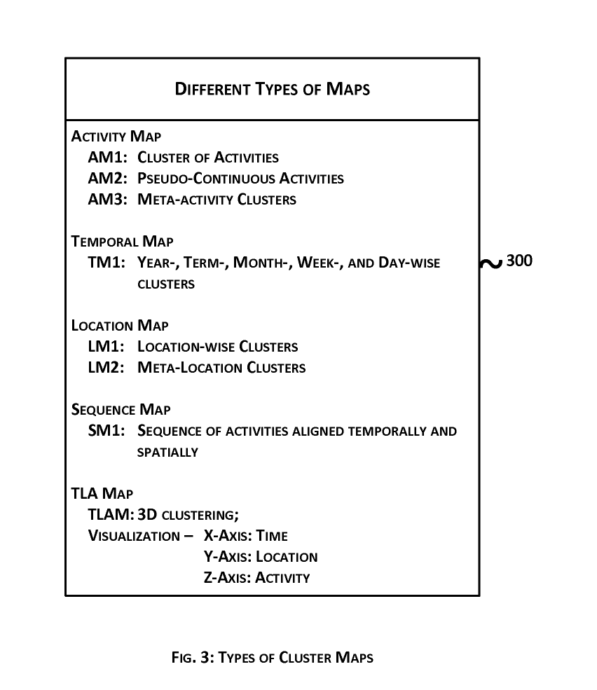

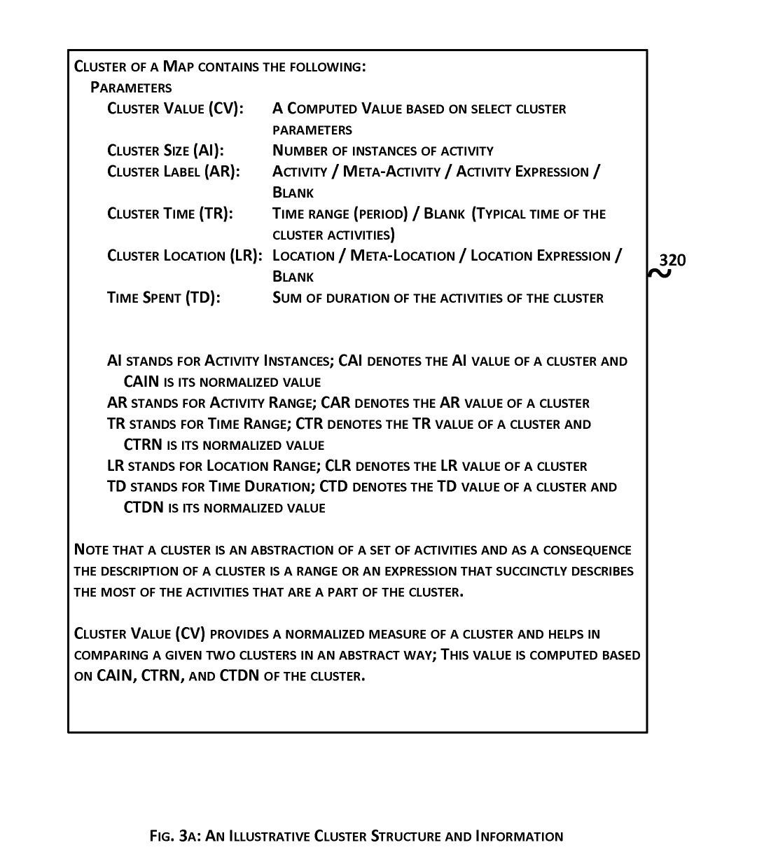

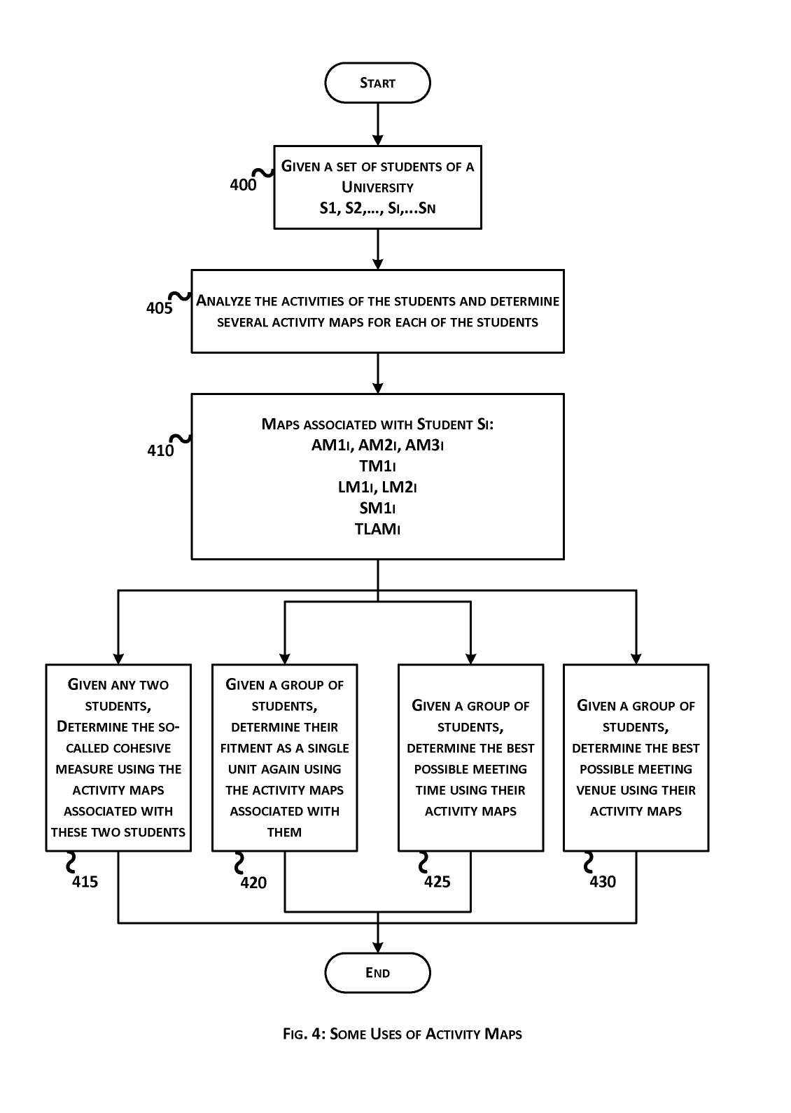

FIG. 2 provides a typical list of student-related processes. This list is arrived at based on the deep domain analysis of a university and is from the point of view of STUDENT entity (200). Specifically, this list categorizes the various activities performed by a typical student within a university. Note that the holistic analysis of a student involves how these activities are performed by the student: for example, a typical behavior of the student in a classroom provides for certain characteristics of the student from the assessment point of view; similarly is the case of the student making a presentation.

FIG. 2A provides a typical list of student-related meta-activities. For example, Curricular, Co-Curricular, Extra-Curricular, Study, and Guiding (220) are an illustrative meta-activities. Meta-activities provide an opportunity to group certain base activities.

FIG. 2B provides a typical list of student locations. The typical list of student locations (250) include (a) Auditorium; (b) Cafeteria; (c) Classroom; (d) Conference-room; (e) Department; (f) Faculty-room; (g) Lab; (h) Library; (i) Social-activity-location; (j) Sports-field; and (k) Study-room.

FIG. 2C provides an illustrative list of meta-locations. Each of the meta-locations defines a possible group of student locations. The list of typical meta-locations include (260) (a) Discussion Location comprising Classroom, Cafeteria, Library, Study-room, Auditorium; (b) Study Location comprising Study-room, Library; (c) Presentation Location comprising Classroom, Conference-room; (d) Participation Location comprising Auditorium, Social-activity-location, Sports-field; (e) Practice Location comprising Auditorium, Social-activity-location, Sports-field; and (f) View Location comprising Auditorium, Social-activity-location, Sports-field. One of the reasons for introducing the notion of meta-locations is to account for variabilities and be able to abstract and identify patterns in spite of these variations. For the same reason, typical time intervals are identified.

FIG. 2D provides a typical list of time intervals. Each of these intervals subsumes a range of time points. A typical list of time intervals include (270), Year-wise, Term-wise (say, a semester), Month-wise, Week-wise, and Day-wise.

FIG. 3 depicts the various types or kinds of activity maps. Broadly, five distinct maps are defined (300): activity map (AM), temporal map (TM), location map (LM), sequence map (SM), and temporal-location-activity map (TLAM). Please note that in the following, map and cluster are used interchangeably.

An activity map provides information about the various activities over a period of time: that is, given a set of activities of a student, the activity map elaborates the activities that seem to be of interest to the student. The activities under consideration could be meta-activities as well. Hence, as depicted in the figure, there are three kinds of activity maps: AM1 related to the cluster of activities; AM2 related to the cluster of pseudo-continuous activities; and AM3 related to the cluster of meta-activities. AM2 brings out a way to discover a pattern from the seemingly unrelated activities based on their respective activity time periods.

A temporal map provides information about the various activities with respect to their similarity along the period of these activities. A year-wise temporal map identifies the prominent activities over a period of one year across several years. Similarly, a term-wise temporal map identifies the prominent activities over a period of a given term, say, half-year, a month-wise temporal map identifies the prominent activities over a period of one month across several months, a week-wise temporal map identifies the prominent activities over a period of a week across several weeks, and a day-wise temporal map identifies the prominent activities over a day across several days. Note that month-wise temporal map can also be with respect to a particular month, say, January, and day-wise temporal map can also be with respect to a particular day, say, Monday. TM1 is a temporal cluster with respect to a period of interest, say, year, term, month, week, or day.

A location map provides information about the various activities with respect to their similarity along the location or meta-location of the activities. LM1 is the cluster of activities with respect to their location similarity and LM2 is the cluster of activities with respect to their meta-location similarity.

A sequence map provides information about the various activities that correlate with respect to time and location. SM1 is the sequence of activities aligned temporally and spatially.

A temporal-location-activity map is based on a 3-dimensional clustering based on the time period and the location of the various similar activities and for visualization purposes time gets depicted along x-axis, location along y-axis, and activity along z-axis.

FIG. 3A provides an illustrative cluster structure and related information.

A cluster or map is an abstraction or summarization of a set of activities and this abstraction is described using a structure as depicted below (320):

### Cluster Structure

Parameters
Cluster Value (CV): A Computed Value based on select cluster parameters
Cluster Size (AI): Number of instances of activity
Cluster Label (Activity Range—AR): Activity/Meta-Activity/Activity Expression/Blank
Cluster Time Range (TR): Time range (period)/Blank (Typical time when the cluster activities get performed)
Cluster Location Range (LR): Location/Meta-Location/Location Expression/Blank
Cluster Duration (Time Spent (TD)): Sum of duration of the activities of the cluster

Each of the parameters helps characterize a map or cluster:

(a) AI indicates the number of activities that have been grouped together in the cluster under consideration and this relatively indicates how relevant this particular cluster is; CAI denotes the AI value of a cluster and CAIN is its normalized value
(b) AR (activity range) is a derived description (label) of the cluster and is based on the description of the activities that are a part of the cluster; CAR denotes the AR value of a cluster
(c) TR (time range) is a derived time period of the cluster and is based on the time period of the activities of the cluster; CTR denotes the TR value of a cluster and CTRN is its normalized value
(d) LR (Location range) is a derived location indicating the abstracted location of the activities of the cluster; CLR denotes the LR value of a cluster
(e) TD (Time duration) is a derived duration information and is based on the duration of the activities of the cluster; CTD denotes the TD value of a cluster and CTDN is its normalized value.

Note that a cluster is an abstraction of a set of activities and as a consequence the description of a cluster is a range or an expression that succinctly describes the most of the activities that are a part of the cluster.

Cluster Value (CV) provides a normalized measure of a cluster and helps in comparing a given two clusters in an abstract way; This value is computed based on CAIN, CTRN, and CTDN of the cluster.

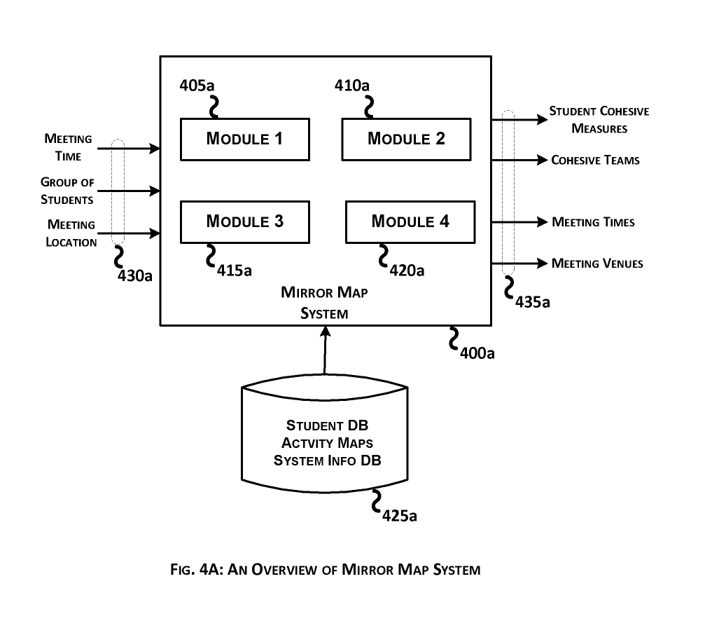

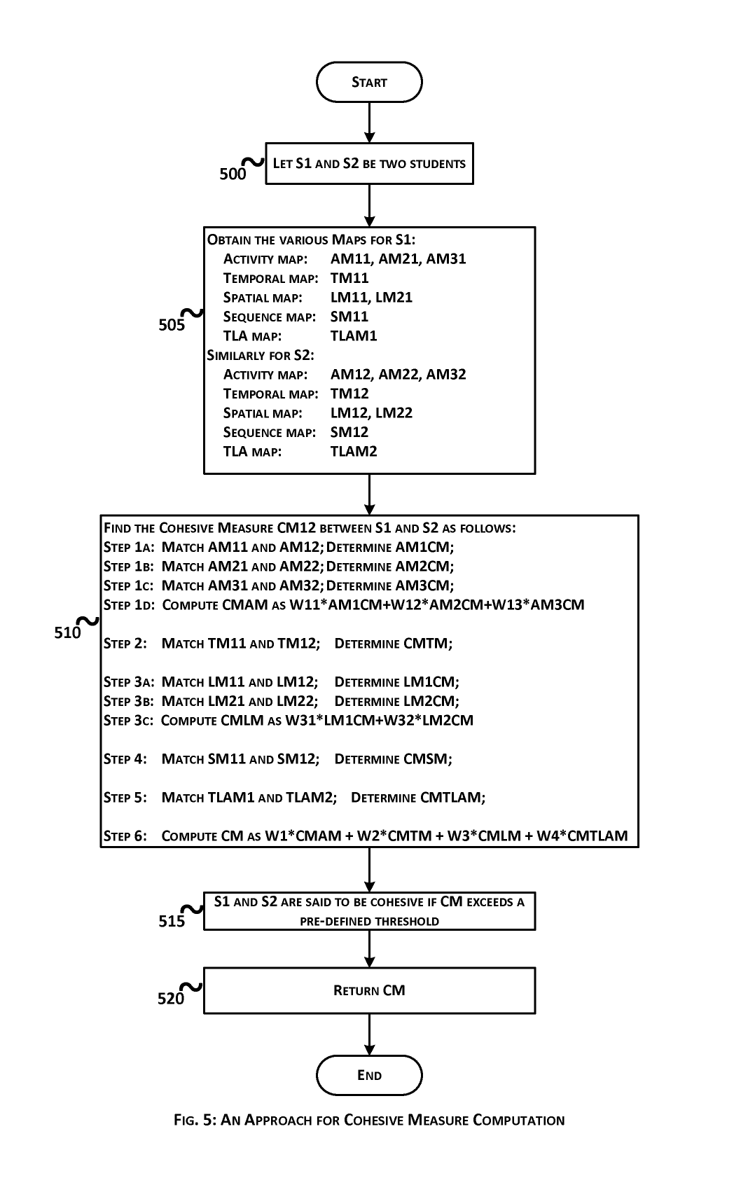

FIG. 4 provides an illustrative list of the uses of the activity maps. The notion of “similar” students, with their corresponding activity maps being the so-called the mirror maps in the sense that the maps correlate with each other, plays an important role in these practically useful applications of the activity maps. The notion of similarity is from various points of view: activity similarity, temporal similarity, and location similarity. Given a set of students (S1, S2, . . . , Si, . . . ) of a university (400), obtain and analyze their activities (405). This analysis leads to the identification of several maps (as described in FIG. 3). The maps associated with a student Si are (410) AM1i, AM2i, AM3i, TM1i, LM1i, LM2i, SM1i, and TLAMi. Some of the uses of these activity maps are provided below:

Application 1 (415): Given any two students, determine the so-called cohesive measure using the activity maps associated with these two students. Such a cohesive measure can be used to determine how “similar” the students are.
Application 2 (420): Given a group of students, determine their fitment as a single unit or team again using the activity maps associated with them. Note that this can be used to form teams for specific purposes such as project teams, sports teams, and cultural teams. In particular, the team can be formed using the determined cohesive measures among the group of students. Note that, given a group or set of students, the following can be achieved: (a) determining a team of students who are notionally “similar;” and (b) determining as many teams, called as cohesive teams, as possible.
Application 3 (425): Given a group of students, determine the best possible meeting time using their activity maps. In particular, the meeting time identification for a group or set of students can be based on the associated TM1s of their activity maps. Note that, given a group or set of students, the following can be achieved: (a) determining a meeting time for a given group of students; (b) determining a team with as many students from the given group as possible, called as maximal team, with a common vacant time slot; here, a time slot defines a period of time and vacant time slot indicates that the students of the maximal team are expected to be free during this time period; the common vacant slot is selected as a meeting time; and (c) determining a team of students from the given group who are expected to be free during the given time period.
Application 4 (430): Given a group of students, determine the best possible meeting venue using their activity maps. In particular, the meeting venue identification for a group or set of students can be based on the associated LM1s and LM2s of their activity maps. Note that, given a group or set of students, the following can be achieved: (a) determining a meeting venue for a given group of students; note that typically the students perform their activities on the university campus in typical locations (refer FIGS. 2B and 2C) and the meeting venues are also expected to be these typical locations; (b) determining a team with as many students from the given group as possible, called as maximal team, with a common location that is expected to suitable for the team; and (c) determining a team of students from the given group for whom the given location (a meeting venue) is expected to be suitable.

FIG. 4A provides an overview of Mirror Map System. Mirror Map System (400a) comprises of four modules:

Module 1 (405a): This module analyses the activity maps of the students from the database (425a) and outputs the student cohesive measures (435a).
Module 2 (410a): This module takes a group of students as input (430a) and the database (425a) and outputs cohesive teams (435a).
Module 3 (415a): This module takes a group of students as input (430a) and optionally a meeting, and outputs meeting times (435a) and optionally a team of students.
Module 4 (420a): This modules take a group of students as input (430a) and optionally a meeting location (or venue), and outputs meeting venues (435a) and optional a team of students.

Typically, Mirror Map System is realized on a computer with one or more processors, main memory to store the models and secondary memory (storage) to hold the database. The modules are executed on the computer and take the required input(s) as depicted in FIG. 4A and generate the output(s) again as depicted in FIG. 4A.

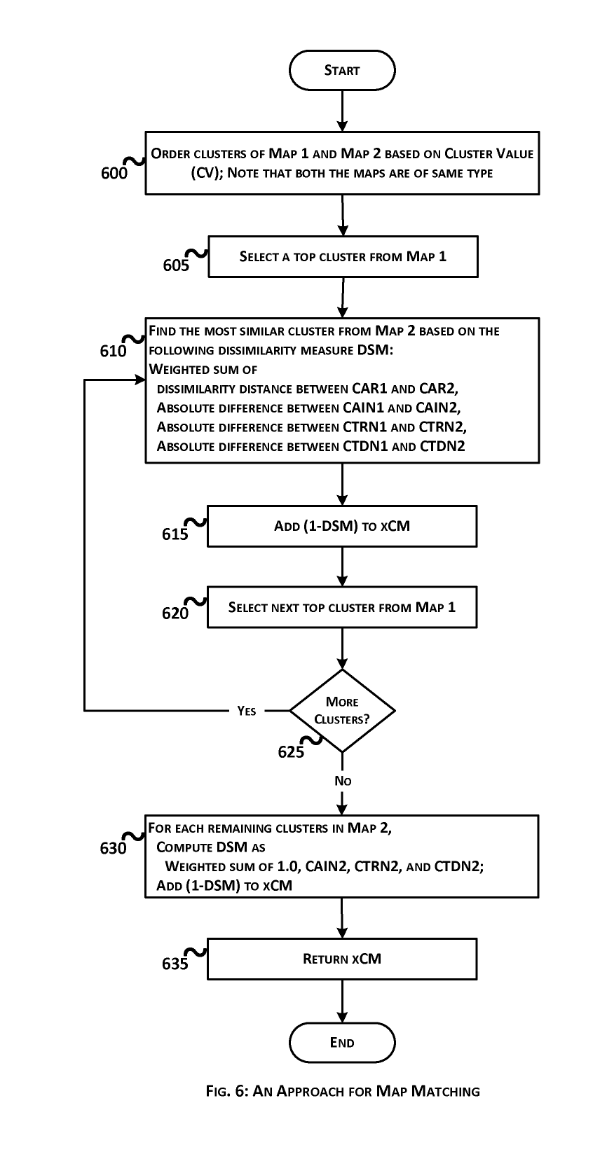

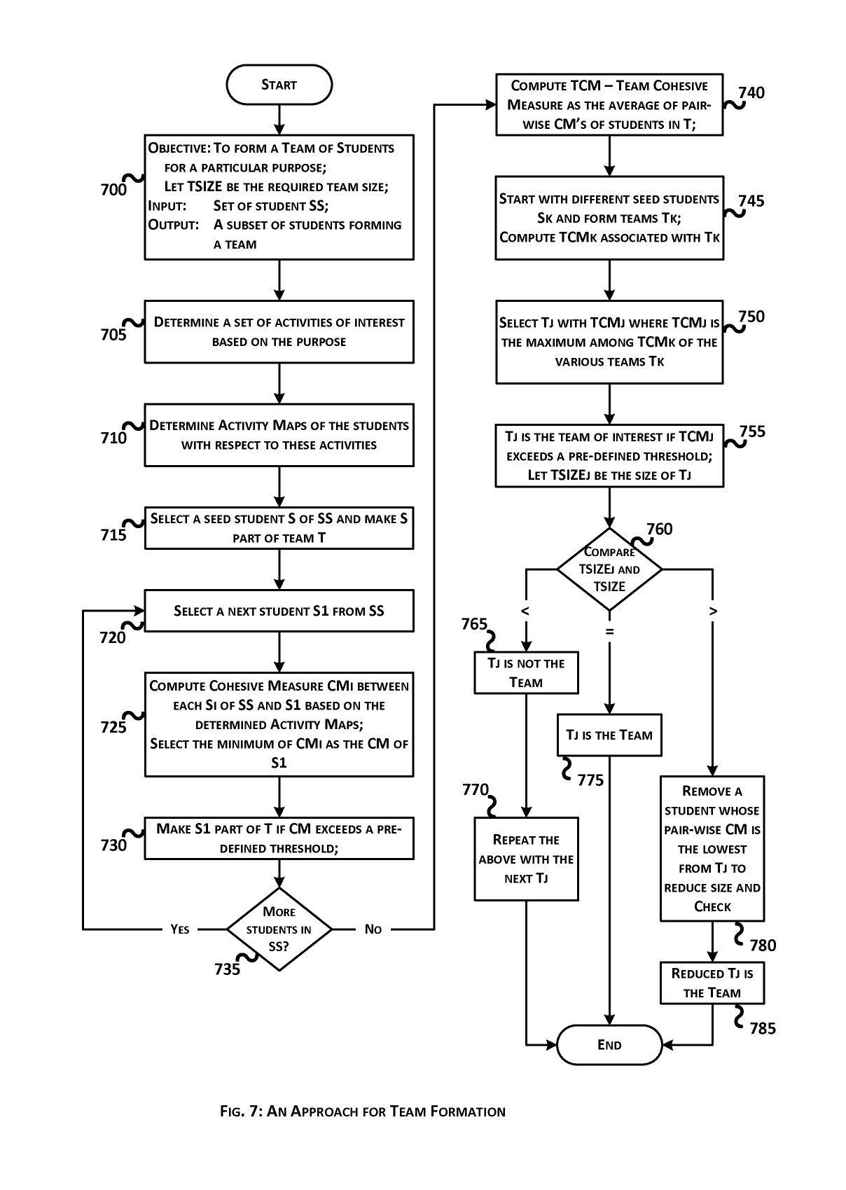

FIG. 5 provides an approach for cohesive measure computation.

Let S1 and S2 be two students (500). Obtain the various Maps (505) for S1:
Activity map: AM11, AM21, AM31
Temporal map: TM11
Spatial map: LM11, LM21
Sequence map: SM11
TLA map: TLAM1

### Similarly for S2:

Activity map: AM12, AM22, AM32
Temporal map: TM12
Spatial map: LM12, LM22
Sequence map: SM12
TLA map: TLAM2

Find the Cohesive Measure CM12 between S1 and S2 as follows (510):

### Step 1a: Match AM11 and AM12; Determine AM1CM;

### Step 1b: Match AM21 and AM22; Determine AM2CM;

### Step 1c: Match AM31 and AM32; Determine AM3CM;

### Step 1d: Compute CMAM as W11*AM1CM+W12*AM2CM+W13*AM3CM

### Step 2: Match TM11 and TM12; Determine CMTM;

### Step 3a: Match LM11 and LM12; Determine LM1CM;

### Step 3b: Match LM21 and LM22; Determine LM2CM;

### Step 3c: Compute CMLM as W31*LM1CM+W32*LM2CM

### Step 4: Match SM11 and SM12; Determine CMSM;

### Step 5: Match TLAM1 and TLAM2; Determine CMTLAM;

### Step 6: Compute CM as W1*CMAM+W2*CMTM+W3*CMLM+W4*CMTLAM

The idea here is to match map by map to determine how each of these maps of S1 correlate with the corresponding maps of the S2. Two different levels of aggregation are performed: one at the map level and the second to arrive at the cohesive measure CM. The weighted aggregation model provides an opportunity to incorporate the preferences.

S1 and S2 are said to be cohesive if CM exceeds a pre-defined threshold (515) and if so, CM defines the cohesive measure (520).

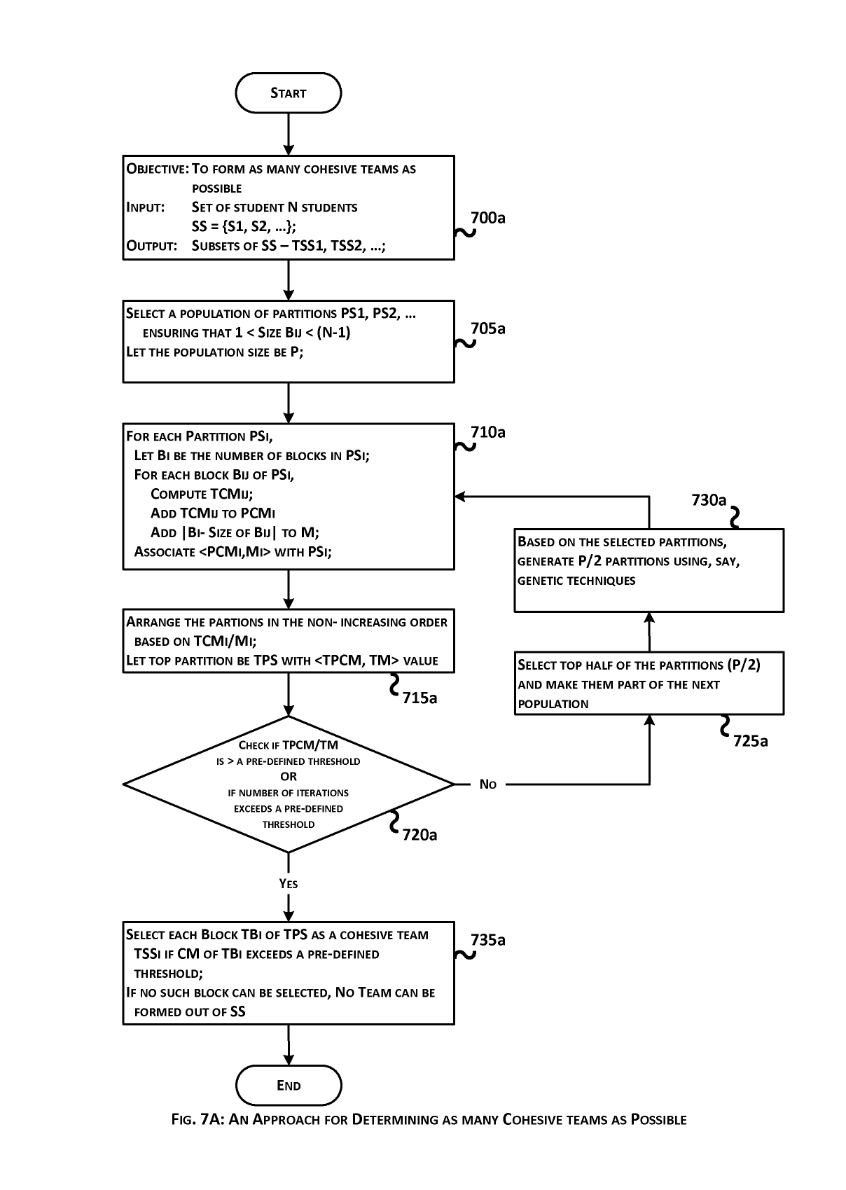

FIG. 6 provides an approach for map matching. Given two maps of the same type or kind to be matched, order clusters of Map 1 and Map 2 based on Cluster Value (CV) (600). Note that a map consists of one or more clusters and both the maps being matched are of the same type. The matching is performed cluster by cluster. Select a top cluster from Map 1 (605). Find the most similar cluster from Map 2 based on the following dissimilarity measure DSM (610):

Weighted sum of
Dissimilarity distance between two CAR1 and CAR2,
Absolute difference between CAIN1 and CAIN2,
Absolute difference between CTRN1 and CTRN2,
Absolute difference between CTDN1 and CTDN2

Note that the dissimilarity measure is based on the similarity between two activity expression and for example, the dissimilarity measure can be simply (1−similarity measure) wherein the similarity measure is a value between 0 and 1. The reason for using the dissimilarity measure is because the other components of the weighted sum arevindeed dissimilarity measures.

Add (1−DSM) to xCM (615). Note that as CM is a measure of cohesiveness and hence the similarity, (1−DSM) gets added to xCM. Here, xCM is an indication of cohesiveness (or similarity) based on a particular pair of maps.

Select next top cluster from Map 1 (620) if there are more clusters yet to be matched in Map 1 (625). If so, repeat the above steps starting from Step 610. Otherwise, account for the clusters that still remain unmatched in Map 2 (630).

For each remaining clusters in Map 2,
Compute DSM as
   Weighted sum of 1.0, CAIN2, CTRN2, and CTDN2;
Add (1−DSM) to xCM

Finally, the xCM is the cohesive measure at a particular map level (635).

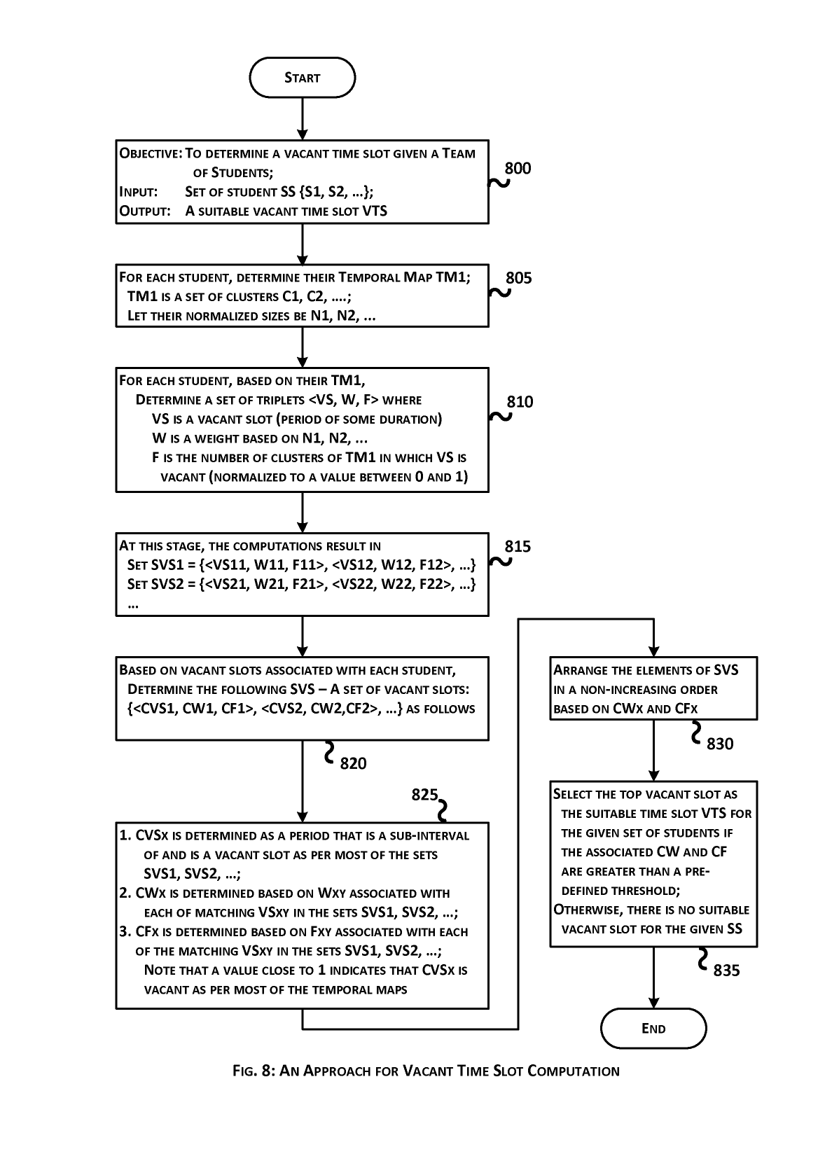

FIG. 7 provides an approach for team formation.

The objective (700) here is to form a Team of Students for a particular purpose. For example, the purpose could be to form a project team or a cultural team. Let TSIZE be the required team size.

The input is a set of student SS and the output is a subset of students forming a team.

Determine a set of activities of interest based on the purpose (705). Note that the set of activities of interest for a cultural activity can be quite different from the set of activities related to a sports team.

Determine Activity Maps of the students with respect to these activities (710).

Select a seed student S of SS and make S part of team T (715). Note that T is also called as a candidate team.

Select a next student S1 from SS (720).

Compute a set of Cohesive Measures {CM1, CM2, . . . } by computing cohesive measure between S1 and each Si of SS based on the determined Activity Maps (725);

Compute the typical cohesive measure, say, by selecting the minimum of {CM1, CM2, . . . } as the CM of S1.

Make S1 part of T if CM exceeds a pre-defined threshold (730).

If there are more students yet to be analyzed (735), repeat the above steps from 720.

Otherwise, compute TCM—Team Cohesive Measure (also called as candidate team cohesive measure) as the average of pair-wise CM's of students (also called as candidate students) in T (740).

Since different seed students can potentially lead to quite distinct teams, start with different seed students Sk (consider as many or all) and form teams T1, T2, Tk, . . . (745); Compute TCM1, TCM2, TCMk, . . . associated with each of these teams. That is, compute TCM1, TCMk, . . . team cohesive measures based on distinct seed students. Select Tj (called as the best team) with TCMj (the best team cohesive measure) where TCMj is the maximum among TCMk of the various teams Tk (750).

Tj is the team of interest if TCMj exceeds a pre-defined threshold (755);

Let TSIZEj (best team size) be the size of Tj. Compare TSIZEj and TSIZE (760): If two sizes are equal, then Tj is the team (775). If TSIZEj is greater than TSIZE, remove a student whose pair-wise CM is the lowest from Tj to reduce size (780) and check; repeat this step until TSIZEj becomes equal to TSIZE. The reduced Tj is the Team (785). Finally, if TSIZEj is <TSIZE, then Tj is the not the team of interest (765). Repeat the above steps with the next Tj (770). That is, consider the next team formed with a different seed student and repeat from Step 755.

FIG. 7A provides an approach for determining as many cohesive teams as possible.

The objective is to form as many cohesive teams as possible (700a) given a group or set of student N students SS={S1, S2, . . . } as input. It is required to output multiple subsets of SS−TSS1, TSS2, . . . . Note that each TSSi identifies a cohesive team.

Select a population of partitions PS1, PS2, . . . ensuring that 1<Size Bij<(N−1) (705a). Note that the condition of Size Bij that defines the block size avoids extreme blocks that are of little interest for the purpose at hand and the upper bound is also referred as the limit number of students. Let the population size be P. Here, a partition PSi comprises of several blocks Bi1, Bi2, . . . such that each Bij is a subset of SS. Size Bij defines the number of elements of the subset Bij.

Compute the measure of each partition as follows (710a):

For each Partition PSi,
Let Bi be the number of blocks in PSi;
For each block Bij of PSi,
   Compute TCMij;
   Add TCMij to PCMi
   Add |Bi−Size of Bij| to M; (Note that |Bi−Size of Bij| is also referred as a block measure)
Associate <PCMI,Mi> with PSi.

Note that each partition is a candidate solution (in the sense of a stochastic optimization technique) and each block is a candidate team. The pair <PCMi, Mi> denotes a partition measure with a Partition Cohesive Measure (PCMi) and a size measure (Mi). TCMij is a measure of cohesiveness of a team Bij and M associated with a partition is a measure how well the students are distributed over the various teams.

Arrange the partitions in the non-increasing order based on PCMi/Mi (715a).

Let top partition be TPS with <TPCM, TM> value.

Check if TPCM/TM is greater than a pre-defined threshold OR if number of iterations exceed a pre-defined threshold (720a). If so, Select each Block TBi of TPS as a cohesive team TSSi if CM of TBi exceeds a pre-defined threshold (735a). Note that TPS is also referred as the near optimal partition. Also, TBi denotes a team of students and the CM of TBi is the team cohesive measure.

If no such block can be selected, No Team can be formed out of SS.

If it is not so (720a), select top half of the partitions (P/2) and make them part of the next population (725a). Based on the selected partitions, generate P/2 partitions using, say, genetic techniques (730a). Note this is a typical stochastic optimization technique: here, while the optimal results are not always guaranteed, near optimal solutions are discovered by setting an upper bound on the number of iterations or alternatively, on the “nearness” of the solution.

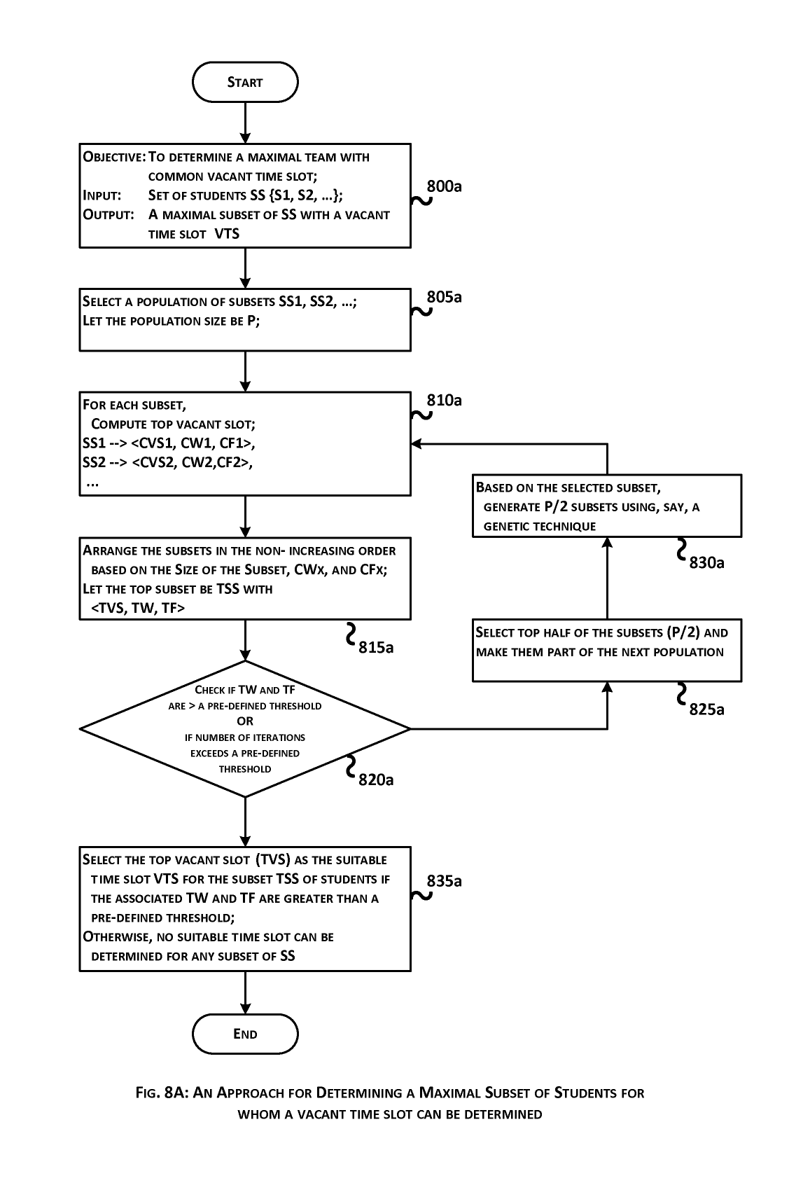

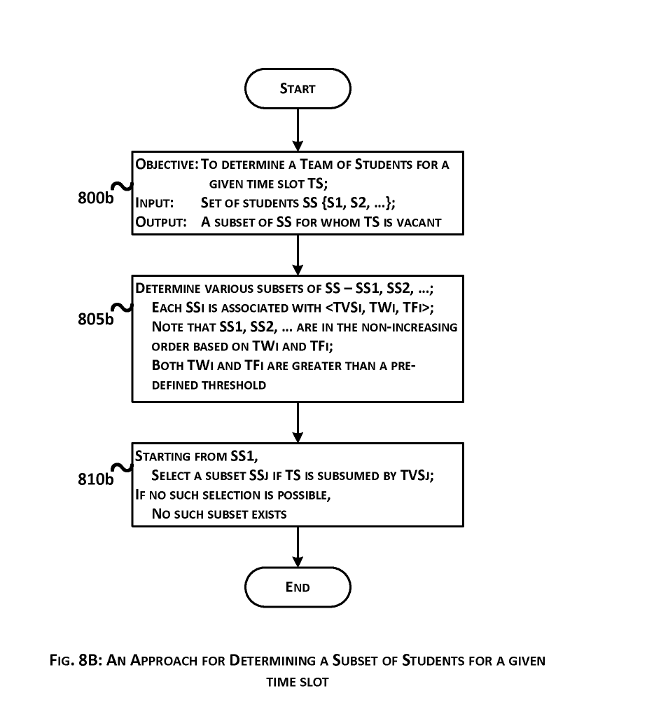

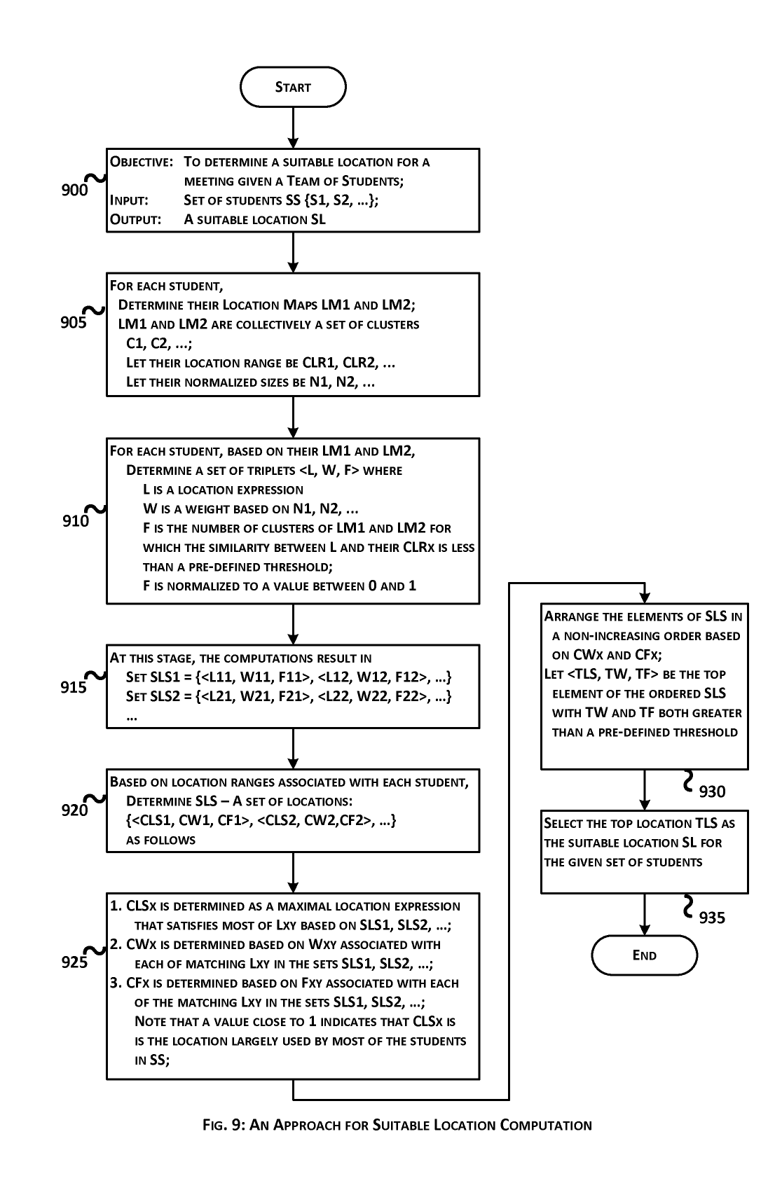

FIG. 8 provides an approach for vacant time slot computation.

The objective is to determine a vacant time slot given a Team of Students (800). Given the input as a set of student SS={S1, S2, . . . }, generate as output a suitable vacant time slot VTS. Here, vacant time slot is the meeting time for the team of students to meet and carryout a discussion.

For each student, determine their Temporal Map TM1 (805). Note that TM1 is a set of clusters C1, C2, . . . , and let their normalized sizes be N1, N2, . . . .

For each student (810), based on their TM1,
Determine a set of triplets <VS, W, F> where
   VS is a vacant slot (period of some duration) as per the set of clusters of TM1;
   W is a normalized weight based on the normalized sizes of the clusters of TM1 in which
      VS is vacant; W is normalized to a value between 0 and 1
   F is the number of clusters of TM1 in which VS is vacant
      Note that F is normalized to a value between 0 and 1 based on the number of clusters in TM1.

At this stage, the computations result in (815)
Set SVS1={<VS11, W11, F11>, <VS12, W12, F12>, . . . }
Set SVS2={<VS21, W21, F21>, <VS22, W22, F22>, . . . }
. . . .

Here, SVS1 is the set of vacant slots related to the student S1 and so on.

Based on vacant slots associated with each student (820), determine the following SVS—a set of vacant slots: {<CVS1, CW1, CF1>, <CVS2, CW2, CF2>, . . . } as follows (825):
1. CVSx, a common vacant slot, is determined as a period that is a sub-interval of and is a vacant slot as per most of the sets SVS1, SVS2, . . . ;
2. CWx, a common weight, is determined based on Wxy associated with each of matching VSxy in the sets SVS1, SVS2, . . . ;
3. CFx, a common frequency, is determined based on Fxy associated with each of the matching VSxy in the sets SVS1, SVS2, . . . ;
   Note that a value close to 1 indicates that CVSx is vacant as per most of the temporal maps.

Note that SVS is also called as a set of common triplets.

Arrange the elements of SVS in a non-increasing order based on CWx and CFx (830).

Select the top vacant slot as the suitable time slot VTS (835) for the given set of students if the associated CW and CF are greater than a pre-defined threshold; Otherwise, there is no suitable vacant slot for the given SS.

As described, VTS is the most suitable time period in which the most of the students of SS are likely to be free.

FIG. 8A provides an approach for determining a maximal subset of students for whom a vacant time slot can be determined.

The objective (800a) is to determine a maximal team with a common vacant time slot given a set of students SS {S1, S2, . . . }. The output is a maximal subset of SS with a possible vacant time slot VTS.

Note that this approach is useful when a common vacant slot cannot be determined for the given set as a whole and hence, it would be ideal to determine a maximal subset for which a common vacant time period exists. The approach involves the use of a stochastic optimization technique to iteratively determine a near optimal solution that results in a relatively better maximal subset. Select a population of subsets SS1, SS2, . . . and let the population size be P (805a).

For each subset (810a),
Compute top vacant slot;

### SS1--><CVS1, CW1, CF1>,

### SS2--><CVS2, CW2, CF2>,

. . . .

Note that this step involves the use of the approach described earlier (FIG. 8 and its corresponding description).

Arrange the subsets in the non-increasing order (815a) based on the Size of the Subset, CWx, and CFx.

Let the top subset be TSS with <TVS, TW, TF>.

Check if TW and TF are both greater than a pre-defined threshold OR if the number of iterations exceeds a pre-defined threshold (820a).

If so, Select the top vacant slot (TVS) as the suitable time slot VTS for the subset TSS of students if the associated TW and TF are greater than a pre-defined threshold (835a); Note that TSS is the near optimal top common triplet.

Otherwise, no suitable time slot can be determined for any subset of SS.

If not so (820a), Select top half of the subsets (P/2) and make them part of the next population (825a).

Based on the selected subset (830a),
generate P/2 subsets using, say, a genetic technique.

The iterations proceed until a fairly accurate result is obtained or the number of iterations exceeds a pre-defined number.

FIG. 8B provides an approach for determining a subset of students for a given time slot. Here, the requirement is to determine a set of students who are likely to be free during the given time slot. The objective is to determine a Team of Students for a given time slot TS (800b). The input is a set of students SS {S1, S2, . . . } and the output is a subset of SS for whom TS is likely to be vacant.

Determine (805b) various subsets of SS—SS1, SS2, . . . ;
Each SSi is associated with <TVSi, TWi, TFi>;
Note that SS1, SS2, . . . are in the non-increasing order based on TWi and TFi;
Both TWi and TFi are both greater than a pre-defined threshold.

Note that the set {<TVS1, TW1, TF1>, <TVS2, TW2, TF2>, . . . >} is a set of ordered near optimal top common triplets and this step uses the approaches described earlier (FIG. 8 and FIG. 8a, and their corresponding descriptions). Further observe the following:

Consider a top common triplet <TVSi, TWi, TFi>;

In this case, the set of considered triplets are {<TVS1, TW1, TF1>, <TVSi−1, TWi−1, TFi−1>} and is ordered as well. Further, the top common triplet <TVSi, TWi, TFi> appears just after the last triplet <TVSi−1, TWi−1, TFi−1> in the set of ordered near optimal top common triplets.

Starting from SS1 (810b),
Select a subset SSj if TS is subsumed by TVSj; Note that SSj is the desired output;

If no such selection is possible,
No such subset exists.

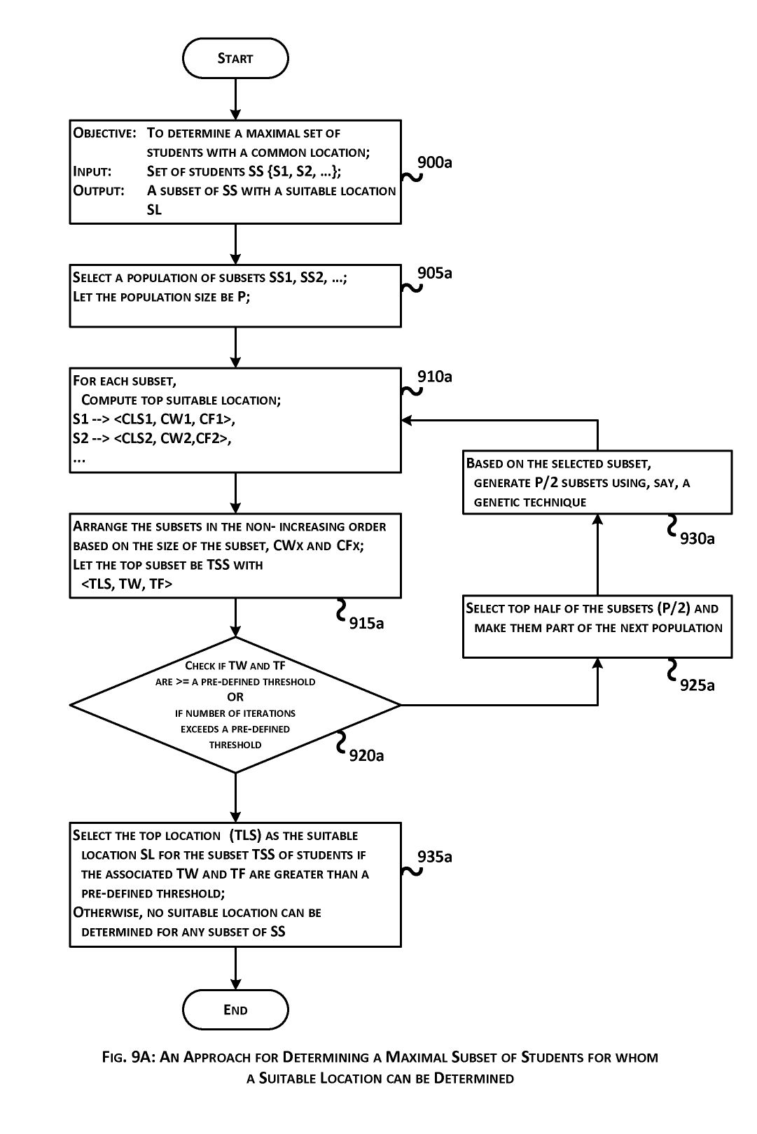

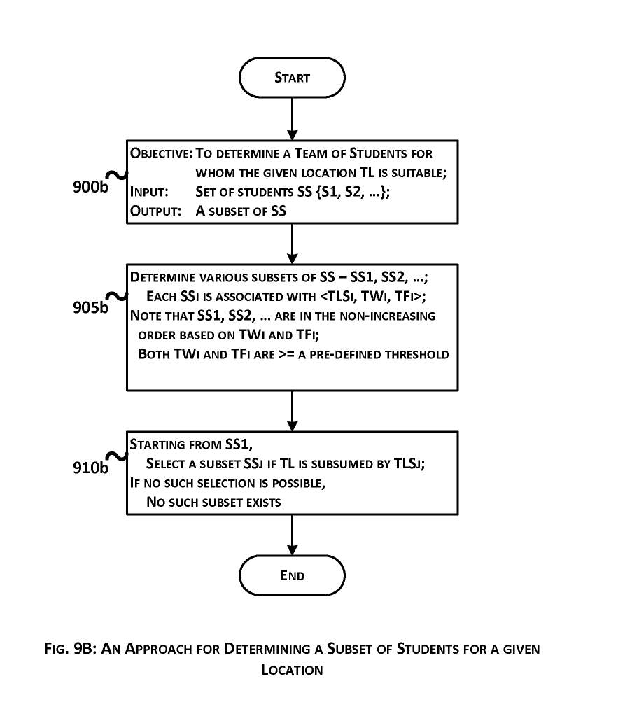

FIG. 9 provides an approach for suitable location computation. This approach elaborates how a suitable location can be determined for a given set of students.

The objective is to determine a suitable location for a meeting given a Team of Students (900).

The input is a set or group of students SS {S1, S2, . . . } and the expected output is a suitable location SL that is suitable to the group of students SS. Note that the suitable location is the meeting venue for the group of students SS.

For each student (905),
Determine their Location Maps LM1 and LM2;
LM1 and LM2 are collectively a set of clusters SC={C1, C2, . . . };
   Let their location range be CLR1, CLR2, . . . ;
   Let their normalized sizes be N1, N2, . . . ;

For each student (910), based on their LM1 and LM2,
Determine a set of triplets <L, W, F> where
   L is a location expression
   W is a weight based on Ni
   F is the number of clusters of SC for which the similarity between L and
      their CLRx is less than a pre-defined threshold;
      F is normalized to a value between 0 and 1 based on the number of clusters in SC.

At this stage (915), the computations result in
Set SLS1={<L11, W11, F11>, <L12, W12, F12>, . . . }
Set SLS2={<L21, W21, F21>, <L22, W22, F22>, . . . }
. . . .

Note that SLS1 corresponds to the locations of the student S1 and so on. Further, set SLS1 defines a plurality of triplets and SLS1, SLS2, . . . collectively form a set of plurality of triplets.

Based on location ranges associated with each student (920), Determine SLS—a set of locations:
{<CLS1, CW1, CF1>, <CLS2, CW2, CF2>, . . . }
as follows (925):
1. CLSx, a common location expression, is determined as a maximal location expression that satisfies most of Lxy based on SLS1, SLS2, . . . ; A plurality of matched triplets is determined based on those triplets of SLS1, SLS2, . . . whose Lxy is satisfied by CLSx;
2. CWx, a common weight, is determined based on Wxy associated with each of matching Lxy in the sets SLS1, SLS2, . . . ;
3. CFx, a common frequency, is determined based on Fxy associated with each of the matching Lxy in the sets SLS1, SLS2, . . . ;
   Note that a value close to 1 indicates that CLSx is the location (that is, venue) largely used by most of the students in SS;

Note that each <CLSx, CWx, CFx> is a common triplet.

Arrange the elements of SLS in a non-increasing order based on CWx and CFx (930);

Let <TLS, TW, TF> be the top element of the ordered SLS with both TW and TF being greater than a pre-defined threshold.

Select the top location TLS as the suitable location SL for the given set of students (935).

FIG. 9A provides an approach for determining a maximal subset of students for whom a suitable location can be determined. The requirement here is to find a suitable location for most of the students of a given set of students when it is not possible to determine the same for the entire set. Note that the suitable location is the possible meeting venue for the maximal subset of students. The objective is to determine a maximal set of students with a common location (900a). The input is a set of students SS {S1, S2, . . . } and the output is a subset of SS with a suitable location SL. Select a population of subsets SS1, SS2, . . . and let the population size be P (905a).

For each subset (910a),
Compute top suitable location;

### SS1--><CLS1, CW1, CF1>,

### SS2--><CLS2, CW2, CF2>,

. . . .

Note that this step involves the use of the approach described earlier (FIG. 9 and its corresponding description). <CLS1, CW1, CF1> is a top common triplet associated with the subset SS1. Arrange the subsets in the non-increasing order based on the size of the subset, CWx and CFx (915a). Let the top subset be TSS with <TLS, TW, TF>. Not

Check if TW and TF both are greater than a pre-defined threshold OR if number of iterations exceeds a pre-defined threshold (920a).

If so, Select the top location (TLS) as the suitable location SL for the subset TSS of students if the associated TW and TF are greater than a pre-defined threshold (935a). Note that TSS is the near optimal top common triplet.

Otherwise, no suitable location can be determined for any subset of SS.

If not so (920a), Select top half of the subsets (P/2) and make them part of the next population (925a).

Based on the selected subset, generate P/2 subsets using, say, genetic techniques (930a).

Perform as many iterations as possible to generate a solution with a reasonable accuracy.

FIG. 9B provides an approach for determining a subset of students for a given location.

The objective is to determine a Team of Students for whom the given location TL is suitable (900b).

The input is a set of students SS {S1, S2, . . . } and the expected output is a subset of SS for whole TL is a suitable location.

Determine various subsets of SS—SS1, SS2, . . . (905b):
Each SSi is associated with <TLSi, TWi, TFi>;
   Note that SS1, SS2, . . . are in the non-increasing order based on TWi and TFi;
   Both TWi and TFi are >=a pre-defined threshold.

Note that the set {<TLS1, TW1, TF1>, <TLS2, TW2, TF2>, . . . >} is a set of ordered near optimal top common triplets and this step uses the approaches described earlier (FIG. 9 and FIG. 9a, and their corresponding descriptions). Further observe the following:

Consider a top common triplet <TLSi, TWi, TFi>;

In this case, the set of considered triplets are {<TLS1, TW1, TF1>, <TLSi−1, TWi−1, TFi−1>} and is ordered as well. Further, the top common triplet <TLSi, TWi, TFi> appears just after the last triplet <TLSi−1, TWi−1, TFi-1> in the set of ordered near optimal top common triplets.

Starting from SS1 (910b),
Select a subset SSj if TL is subsumed by TLSj;
Note that SSj is the desired subset of students for TL is suitable;

If no such selection is possible,
No such subset exists.

Thus, a system and method for determining of a cohesive team, meeting time, and meeting venue in a university is disclosed. Although the present invention has been described particularly with reference to the figures, it will be apparent to one of the ordinary skill in the art that the present invention may appear in any number of systems that provide for the various practical applications of student activity maps. It is further contemplated that many changes and modifications may be made by one of ordinary skill in the art without departing from the spirit and scope of the present invention.

We claim:

1. A computer implemented method for determining a plurality of teams of a plurality of students of a university, a plurality of meeting times associated with said plurality of students, and a plurality of meeting venues associated with said plurality of students based on a plurality of activity maps of said plurality of students in the context of said university, wherein said plurality of activity maps comprises of a plurality of AM1s, a plurality of AM2s, a plurality of AM3s, a plurality of TM1s, a plurality of LM1s, a plurality of LM2s, a plurality of SM1s, and a plurality of TLAMs, an activity map of said plurality of activity maps comprises of a plurality of clusters with a cluster of said plurality of cluster comprising a CV, a CAI, a CAIN, a CAR, a CTR, a CTRN, a CLR, a CTD, and a CTDN,
the method performed on a computer system comprising at least one processor,
said method comprising the steps of:
computing, with at least one processor, a plurality of cohesive measures associated with said plurality of students based on said plurality of activity maps;
computing, with at least one processor, a team of said plurality of teams based on said plurality of students and said plurality of cohesive measures;
computing, with at least one processor, a plurality of cohesive teams of said plurality of teams based on said plurality of cohesive measures;
computing, with at least one processor, a meeting time of said plurality of meeting times for said plurality of students based on said plurality of TM1s of said plurality of activity maps;
computing, with at least one processor, a maximal team 1 of said plurality of teams with a meeting time of said plurality of meeting times based on said plurality of TM1s;
computing, with at least one processor, a team 1 of said plurality of teams based on a time period of said plurality of meeting times and said plurality of TM1s;
computing, with at least one processor, a meeting venue of said plurality of meeting venues for said plurality of students based on said plurality of LM1s of said plurality of activity maps and said plurality of LM2s of said plurality of activity maps;
computing, with at least one processor, a maximal team 2 of said plurality of teams with a meeting venue of said plurality of meeting venues based on said plurality of LM1s, and said plurality of LM2s; and
computing, with at least one processor, a team 2 of said plurality of teams based on a location of said plurality of meeting venues, said plurality of LM1s, and said plurality of LM2s.

2. The method of claim 1, wherein said step for computing said plurality of cohesive measures further comprises the steps of:
determining a student 1 of said plurality of students;
determining a student 2 of said plurality of students;
determining a plurality of student 1 activity maps based on said student 1 and said plurality of activity maps;
determining a plurality of student 2 activity maps based on said student 2 and said plurality of activity maps;
matching a student 1 AM1 of said plurality of student 1 activity maps and a student 2 AM1 of said plurality of student 2 activity maps to result in a AM1CM;
matching a student 1 AM2 of said plurality of student 1 activity maps and a student 2 AM2 of said plurality of student 2 activity maps to result in a AM2CM;
matching a student 1 AM3 of said plurality of student 1 activity maps and a student 2 AM3 of said plurality of student 2 activity maps to result in a AM3CM;
computing a CMAM based on a plurality of weights, said AM1CM, said AM2CM, and said AM3CM;
matching a student 1 TM1 of said plurality of student 1 activity maps and a student 2 TM1 of said plurality of student 2 activity maps to result in a CMTM;
matching a student 1 LM1 of said plurality of student 1 activity maps and a student 2 LM1 of said plurality of student 2 activity maps to result in a LM1CM;
matching a student 1 LM2 of said plurality of student 1 activity maps and a student 2 LM2 of said plurality of student 2 activity maps to result in a LM2CM;
computing a CMLM based on a plurality of weights, said LM1CM, and said LM2CM;
matching a student 1 SM1 of said plurality of student 1 activity maps and a student 2 SM1 of said plurality of student 2 activity maps to result in a CMSM;
matching a student 1 TLAM of said plurality of student 1 activity maps and a student 2 TLAM of said plurality of student 2 activity maps to result in a CMTLAM; and
computing a cohesive measure of said plurality of cohesive measures based on a plurality of weights, said CMAM, said CMTM, said CMLM, said CMSM, and said CMTLAM.
(REFER FIG. 5)

3. The method of claim 2, wherein said method of matching further comprises the steps of:
determining a plurality of student 1 clusters of said student 1 AM1;
determining a plurality of student 2 clusters of said student 2 AM1;
ordering said plurality of student 1 clusters based on a plurality of CVs associated with said plurality of student 1 clusters to result in a plurality ordered 1 clusters;
ordering said plurality of student 2 clusters based on a plurality of CVs associated with said plurality of student 1 clusters to result in a plurality ordered 2 clusters;
selecting a top 1 cluster from said plurality of ordered 1 cluster;
selecting a most similar 2 cluster based on said top 1 cluster, said plurality of ordered 2 clusters, and a dissimilarity measure of a plurality of dissimilarity measures, wherein said dissimilarity measure is based on
a dissimilarity distance between a CAR 1 of a plurality of 1 CARs of said top 1 cluster and a CAR 2 of a plurality of 2 CARs of said most similar 2 cluster of said plurality of ordered 2 clusters,
an absolute difference between a CAIN 1 of a plurality of 1 CAINs of said top 1 cluster and a CAIN 2 of a plurality of 2 CAINs of said most similar 2 cluster,
an absolute difference between a CTRN 1 of a plurality of 1 CTRNs of said top 1 cluster and a CTRN 2 of a plurality of 2 CTRNs of said most similar 2 cluster, and
an absolute difference between a CTDN 1 of a plurality of 1 CTDNs of said top 1 cluster and a CTDN 2 of a plurality of 2 CTDNs of said most similar 2 cluster,
adding (1−each of said plurality of dissimilarity measures) to an xCM;
selecting a top 2 cluster of said plurality of ordered 2 clusters;
computing a dissimilarity 2 measure of a plurality of dissimilarity 2 measures based on 1.0, a CAIN 2 of a plurality of 2 CAINs of said top 2 cluster, a CTRN 2 of a plurality of 2 CTRNs of said top 2 cluster, and a CTDN 2 of a plurality of 2 CTDNs of said top 2 cluster;
adding (1−each of said plurality of dissimilarity 2 measures) to said xCM; and
making of said xCM as said AM1CM.
(REFER FIG. 6)

4. The method of claim 1, wherein said step for computing said team of said plurality of teams further comprises the steps of:
determining a team size of said team;
determining said plurality of activity maps associated with said plurality of students;
determining a student 1 of said plurality of students;
making of said student 1 a part of a candidate team of a plurality of candidate teams;
determining a student 2 of said plurality of students;
computing a plurality of student 2 cohesive measures based on said student 2, said candidate team, and said plurality of cohesive measures;
computing a typical student 2 cohesive measure based on said plurality of student 2 cohesive measures;
making of said student 2 a part of said candidate team, wherein said typical student 2 cohesive measure exceeds a pre-defined threshold;
computing a candidate team cohesive measure of a plurality of candidate team cohesive measures based on a plurality of typical cohesive measures associated with a plurality of candidate students of said candidate team;
selecting a best team based on said candidate teams, wherein a best team cohesive measure associated with said best team is maximum among said plurality of candidate team cohesive measures;
determining a best team size based on said best team;
removing a student 2 from said best team, wherein said best team size exceeds said team size, a typical cohesive measure of said student 2 is minimum among a plurality of best typical cohesive measures associated with a plurality of best team students of said best team; and
assigning said best team as said team if said best team size is equal to said team size.
(REFER TO FIG. 7)

5. The method of claim 1, wherein said step for computing said plurality of cohesive teams of said plurality of teams further comprises the steps of:
determining said plurality of students;
determining a number of students based on said plurality of students;
determining a limit number of students as one less than said number of students;
determining a plurality of partitions, wherein a block size of a block of a partition of said plurality of partitions is greater than 1 and less than said limit number of students;
computing a partition measure comprising of a partition cohesive measure and a size measure based on a partition of said plurality of partitions;
determining of a plurality of partition measures associated with said plurality of partitions;
computing a near optimal partition based on said plurality of partitions, said plurality of partition measures, and a stochastic optimization technique;
determining a plurality of blocks associated with said near optimal partition; and
selecting a block of said plurality of blocks as a part of said plurality of cohesive teams, wherein a team cohesive measure associated with said block exceeds a pre-defined threshold.
(REFER FIG. 7A)

6. The method of claim 5, wherein said step for computing said partition measure further comprises the steps of:
determining said partition of said plurality of partitions;
determining a plurality of blocks associated with said partition;
computing a number of blocks based on said plurality of blocks;
determining a block of said plurality of blocks;
computing a team cohesive measure associated with said block;
adding said team cohesive measure to said partition cohesive measure;
computing a block measure based on said number of blocks and a size of said block; and
adding said block measure to said size measure.
(REFER FIG. 7A)

7. The method of claim 1, wherein said step for computing said meeting time further comprises the steps of:
determining a student 1 of said plurality of students;
determining a TM1 of said plurality of TM1s based on said student 1;
determining a plurality of clusters associated with said TM1;
determining a number of clusters based on said plurality of clusters;
determining a plurality of normalized sizes of said plurality of clusters;
computing a triplet of a plurality of triplets associated with said student 1 based on said plurality of clusters and said plurality of normalized sizes;
computing a set of plurality of triplets associated with said plurality of students;
computing a common triplet of a plurality of common triplets based on said set of plurality of triplets, wherein said common triplet comprises of a common vacant slot, a common weight, and a common frequency;
arranging said plurality of common triplets in a non-increasing order based on a common weight and a common frequency associated with each of said plurality of common triplets resulting a plurality of ordered common triplets;
selecting a top common triplet based on said plurality of ordered common triplets; and
selecting a top common vacant slot of said top common triplet as said meeting time, wherein a top common weight associated with said top common triplet exceeds a pre-defined threshold, and a top common frequency associated with said top common triplet exceeds a pre-defined threshold.
(REFER FIG. 8)

8. The method of claim 7, wherein said step for computing said triplet further comprises the steps of:
computing a vacant slot of said triplet based on said plurality of clusters, wherein said vacant slot is vacant in a plurality of vacant clusters of said plurality of clusters;
computing a weight of said triplet based on said plurality of normalized sizes and said plurality of vacant clusters, wherein said weight is a normalized value; and
computing a frequency of said triplet based on a number of said plurality of vacant clusters and said number of clusters, wherein said frequency is a normalized value.
(REFER FIG. 8)

9. The method of claim 7, wherein said step for computing said common triplet further comprises the steps of:
computing a common vacant slot of said common triplet based on said set of plurality of triplets, wherein said common vacant slot is vacant in a plurality of vacant triplets of said set of plurality of triplets;
computing a common weight of said common triplet based on a weight associated with each of said plurality of vacant triplets; and
computing a common frequency of said common triplet based on a frequency associated with each of said plurality of vacant triplets.
(REFER FIG. 8)

10. The method of claim 1, wherein said step for computing said maximal team 1 further comprises the steps of:
determining said plurality of students;
determining said plurality of TM1s;
determining a population size;
determining a plurality of student subsets based on said plurality of students and said population size, wherein a student subset of said plurality of student subsets is a subset of said plurality of students;
determining a student subset of said plurality of student subsets;
determining a plurality subset TM1s based on said plurality of TM1s and said student subset;
computing a top common triplet of a plurality of top common triplets based on said plurality of subset TM1s;
determining a plurality of sizes based on a size of each of said plurality of student subsets;
determining a plurality of top common weights based on said plurality of top common triplets;
determining a plurality of top common frequencies based on said plurality of top common triplets;
computing of a near optimal top common triplet based on said plurality of top common triplets, said plurality of student subsets, said population size, said plurality of sizes, said plurality of common weights, and said plurality of common frequencies;
determining a top student subset based on said near optimal common triplet and said plurality of student subsets;
selecting a top common vacant slot of said near optimal top common triplet as said meeting time and said top student subset as said maximal team 1, wherein a common weight associated with said near optimal top common triplet exceeds a pre-defined threshold, and a common frequency associated with said near optimal top common triplet exceeds a pre-defined threshold.
(REFER FIG. 8A)

11. The method of claim 1, wherein said step for computing said team 1 further comprises the steps of:
computing a plurality of ordered near optimal top common triplets based on said plurality of students, said plurality of TM1s, a plurality of top common triplets, a plurality of student subsets, a population size, a plurality of sizes, a plurality of common weights, and a plurality of common frequencies;
determining a plurality of ordered top student subsets based on said plurality of ordered near optimal top common triplets;
selecting a topmost student subset based on said plurality of ordered top student subsets; and
making said topmost student subset as said team 1.
(REFER FIG. 8B)

12. The method of claim 11, wherein said step for selecting further comprises the steps of:
determining a top student subset based on said plurality of ordered top student subsets;
determining a top common triplet associated with said top student subset based on said plurality of ordered near optimal top common triplets;
computing a plurality of considered triplets based on said plurality of ordered near optimal top common triplets and said top common triplet, wherein said top common triplet is just after the last triplet of said plurality of considered triplets in said plurality of ordered near optimal top common triplets;
determining a plurality of considered vacant slots based on said plurality of considered triplets, wherein said time period is not subsumed by each of said plurality of considered vacant slots;
determining a top common vacant slot based on said top common triplet; and
making said top student subset as said topmost student subset, wherein said time period is subsumed by said top common vacant slot.
(REFER FIG. 8B)

13. The method of claim 1, wherein said step for computing said meeting venue further comprises the steps of:
determining a student 1 of said plurality of students;
determining an LM1 of said plurality of LM1s based on said student 1;
determining an LM2 of said plurality of LM2s based on said student 1;
determining a plurality of clusters based on said LM1 and said LM2;
determining a plurality of location ranges based on said plurality of clusters;
determining a plurality of normalized sizes of said plurality of clusters;
computing a triplet of a plurality of triplets associated with said student 1 based on said plurality of clusters and said plurality of normalized sizes;
computing a set of plurality of triplets associated with said plurality of students, wherein said plurality of triplets of said student 1 is a part of said set;
computing a common triplet of a plurality of common triplets based on said set of plurality of triplets, wherein said common triplet comprises of a common location expression, a common weight, and a common frequency;
arranging said plurality of common triplets in a non-increasing order based on a common weight and a common frequency associated with each of said plurality of common triplets resulting a plurality of ordered common triplets;
selecting a top common triplet based on said plurality of ordered common triplets; and
selecting a top common location expression of said top common triplet as said meeting time, wherein a top common weight associated with said top common triplet exceeds a pre-defined threshold, and a top common frequency associated with said top common triplet exceeds a pre-defined threshold.
(REFER FIG. 9)

14. The method of claim 13, wherein said step for computing said triplet further comprises the steps of:
computing a location expression of said triplet based on said plurality of clusters, wherein said location expression is derived from cluster location of each of said plurality of clusters;
computing a weight of said triplet based on said plurality of normalized sizes, wherein said weight is a normalized value; and
computing a frequency of said triplet based on a plurality of matching clusters of said plurality of clusters, wherein a similarity measure between a cluster location of each of said plurality of matching clusters and said location expression is less than a pre-defined threshold and said frequency is a normalized value.
(REFER FIG. 9)

15. The method of claim 13, wherein said step for computing said common triplet further comprises the steps of:
determining a plurality of location expressions based on said set of plurality of triplets;
computing said common location expression of said common triplet based on said set of plurality of triplets, wherein said common location expression matches closely with most of said plurality of location expressions;
determining a plurality of matched triplets of said set based on said common location expression;
computing said common weight of said common triplet based on a weight associated with each of said plurality of matched triplets; and
computing said common frequency of said common triplet based on a frequency associated with each of said plurality of matched triplets.
(REFER FIG. 9)

16. The method of claim 1, wherein said step for computing said maximal team 2 further comprises the steps of:
determining said plurality of students;
determining said plurality of LM1s;
determining said plurality of LM2s;
determining a population size;
determining a plurality of student subsets based on said plurality of students and said population size, wherein a student subset of said plurality of student subsets is a subset of said plurality of students;
determining a student subset of said plurality of student subsets;
determining a plurality subset LMs based on said plurality of LM1s, said plurality of LM2s, and said student subset;
computing a top common triplet of a plurality of top common triplets based on said plurality of subset LMs;
determining a plurality of sizes based on a size of each of said plurality of student subsets;
determining a plurality of top common weights based on said plurality of top common triplets;
determining a plurality of top common frequencies based on said plurality of top common triplets;
computing of a near optimal top common triplet based on said plurality of top common triplets, said plurality of student subsets, said population size, said plurality of sizes, said plurality of common weights, and said plurality of common frequencies;
determining a top student subset based on said near optimal top common triplet and said plurality of student subsets;
selecting a top common location expression of said near optimal top common triplet as said meeting venue and said top student subset as said maximal team 2, wherein a common weight associated with said near optimal top common triplet exceeds a pre-defined threshold, and a common frequency associated with said near optimal top common triplet exceeds a pre-defined threshold.
(REFER FIG. 9A)

17. The method of claim 1, wherein said step for computing said team 2 further comprises the steps of:
computing a plurality of ordered near optimal top common triplets based on a plurality of students, a plurality of LM1s, a plurality of LM2s, a plurality of top common triplets, a plurality of student subsets, a population size, a plurality of sizes, a plurality of common weights, and a plurality of common frequencies;
determining a plurality of ordered top student subsets based on said plurality of ordered near optimal top common triplets;
selecting a topmost student subset based on said plurality of top ordered student subsets; and
making said top student subset as said team 2.
(REFER FIG. 9B)

18. The method of claim 17, wherein said step for selecting further comprises the steps of:
determining a top student subset based on said plurality of ordered top student subsets;
determining a top common triplet associated with said student subset based on said plurality of ordered near optimal top common triplets;
computing a plurality of considered triplets based on said plurality of ordered near optimal top common triplets and said top common triplet, wherein said top common triplet is just after the last triplet of said plurality of considered triplets in said plurality of ordered near optimal top common triplets;
determining a plurality of considered locations based on said plurality of considered triplets, wherein said location not subsumed by each of said plurality of considered locations;
determining a top common location expression based on said top common triplet; and
making said top student subset as said topmost student subset, wherein said location is subsumed by said top common location expression.
